(19) United States
(12) Patent Application Publication
(10) Pub. No.: US 2025/0193312 A1
(43) Pub. Date: Jun. 12, 2025

(54) CONTACT CENTER AGENT STATE MANAGEMENT SYSTEM

(71) Applicant: Afiniti AI Limited, Dublin 2, Dublin (IE)

(72) Inventors: Asif Muhammad IBRAHIM, Karachi (PK); Ain CHISHTY, Rockville, MD (US)

(73) Assignee: Afiniti AI Limited, Dublin 2, Dublin (IE)

(21) Appl. No.: 19/059,673

(22) Filed: Feb. 21, 2025

Related U.S. Application Data
(63) Continuation of application No. PCT/US2023/031391, filed on Aug. 29, 2023.
(60) Provisional application No. 63/402,563, filed on Aug. 31, 2022.

(51) Int. Cl. H04M 3/51; G06F 9/54

(52) U.S. Cl. CPC H04M 3/5175; G06F 9/542

(57) ABSTRACT

A pairing node comprising memory and processing circuitry coupled to the memory, wherein the pairing node is configured to: obtain an event indicator (EI) indicating an event for an agent; obtain a current state object (CSO) for the agent, the CSO comprising a current state indicator (CSI) indicating a current state of the agent and a pending state indicator (PSI) indicating a pending state for the agent; use the EI and at least one of the CSI or PSI to obtain an index value; use the index value and at least one of the CSI or PSI to obtain a new state object (NSO) for the agent; and associate the NSO with an agent identifier (AI) associated with the agent.

### CROSS-REFERENCE TO RELATED APPLICATIONS

This application is a bypass continuation of International Patent Application No. PCT/US2023/031391, filed on 2023 Aug. 29, which claims the benefit of U.S. Provisional Patent Application No. 63/402,563, filed on 2022 Aug. 31. The above identified applications are incorporated by this reference.

### TECHNICAL FIELD

Disclosed are embodiments related to a contact center agent state management system.

### BACKGROUND

A contact center functions to assign contacts to contact center agents (or “agents” for short) available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment. It is important that the contact center maintain state information (SI) for each agent. In a typical contact center, any given agent, at any given time, is in one of several possible agent states; additionally, when an event for an agent is detected, the agent transitions from its current state to a new state and the agent state management system updates the SI for the agent to reflect the new state.

### SUMMARY

Certain challenges presently exist. For instance, at any given time an agent may exist in one of multiple possible states (e.g., idle, logged out, on-break, on-call, after-call work (ACW), etc.) and, while in a particular state (e.g., idle), may transition to a new state (e.g., on-call) in response to an event (e.g., call connected). In a contact center that has a large number of agents that handle a large call volume, it can be challenging to keep track of each agents state in a timely manner.

Accordingly, in one aspect there is provided a pairing node comprising memory and processing circuitry coupled to the memory, wherein the pairing node is configured to: obtain an event indicator (EI) indicating an event for an agent; obtain a current state object (CSO) for the agent, the CSO comprising a current state indicator (CSI) indicating a current state of the agent and a pending state indicator (PSI) indicating a pending state for the agent; use the EI and at least one of the CSI or PSI to obtain an index value; use the index value and at least one of the CSI or PSI to obtain a new state object (NSO) for the agent; and associate the NSO with an agent identifier (AI) associated with the agent.

In one embodiment, the pairing node is configured to use the index value and at least one of the CSI or PSI to obtain the NSO by performing a process that comprises: using the index value to select a row from an agent state transition management data table; and using the CSI or PSI to select a field from the selected row, wherein the selected field comprises the NSO.

In one embodiment, the pairing node is configured to use the EI and PSI to obtain the index value by evaluating a function of at least: EI, PSI, and a load indicator (LI).

In one embodiment, evaluating the function comprises calculating one of: EI+PSI−LI, EI×PSI/Interval+LI, (EI−ESV)/Interval+PSI×TE×2+LI, or LI×Interval+PSI×TE−EI, where TE is a total number of possible events, ESV is an event starting value, and Interval is spacing interval.

In one embodiment, the pairing node is configured to obtain the EI by reading from a message queue a message that comprises the EI.

In one embodiment, the pairing node is configured to obtain the CSO for the agent by using the AI to retrieve the CSO from a shared memory.

In one embodiment, the message further comprises the AI, and the pairing node is configured to obtain the AI from the message prior to using the AI to retrieve the CSO.

In one embodiment, the pairing node is configured to associate the NSO with the AI by storing the NSO in a memory location associated with the AI.

In another aspect, there is provided a pairing node comprising memory and processing circuitry coupled to the memory, wherein the pairing node is configured to: obtain a first event message associated with a first agent, wherein the first event message comprises a first agent identifier (AI) associated with the first agent; use the first AI to obtain a first queue identifier (QI); and add the first event message to a message queue associated with the first QI.

In one embodiment, the pairing node is configured to obtain the first event message by generating the first event message.

In one embodiment, the pairing node comprises a first message queue (MQ1) for storing the first event message, and the pairing node is configured to obtain the first event message by reading the first event message from MQ1.

In one embodiment, the pairing node is further configured to remove the first event message from MQI after adding the first event message to the message queue associated with the first QI.

In one embodiment, the pairing node is further operable to: obtain a second event message associated with a second agent, wherein the second event message comprises a second AI associated with the second agent; use the second AI to obtain a second QI; and add the second event message to a message queue associated with the second QI.

In one embodiment, the second QI identifies the same message queue as the first QI.

In one embodiment, the second QI identifies a different message queue than the first QI, and the pairing node is further configured to: initiate a first message handler (MH) for processing messages in the message queue associated with the first QI; and initiate a second MH for processing messages in the message queue associated with the second QI.

In another aspect there is provided a method that includes: obtaining an event indicator (EI) indicating an event for an agent; obtaining a current state object (CSO) for the agent, the CSO comprising a current state indicator (CSI) indicating a current state of the agent and a pending state indicator (PSI) indicating a pending state for the agent; using the EI and at least one of the CSI or PSI to obtain an index value; using the index value and at least one of the CSI or PSI to obtain a new state object (NSO) for the agent; and associating the NSO with an agent identifier (AI) associated with the agent.

In another aspect there is a method that includes obtaining a first event message associated with a first agent, wherein the first event message comprises a first agent identifier (AI) associated with the first agent; using the first AI to obtain a first queue identifier (QI); and adding the first event message to a message queue associated with the first QI.

### BRIEF DESCRIPTION OF THE DRAWINGS

The accompanying drawings, which are incorporated herein and form part of the specification, illustrate various embodiments.

FIG. 1A illustrates an example communication system according to an embodiment.

FIG. 1B illustrates an example communication system according to an embodiment.

FIG. 1C illustrates an example communication system according to an embodiment.

FIG. 1D illustrates an example communication system according to an embodiment.

FIG. 2 illustrates a paring node of a contact center according to an embodiment.

FIG. 3 illustrates a block diagram of a task assignment system with an external pairing system according to an embodiment.

FIG. 4 is a flowchart illustrating a process according to an embodiment.

FIG. 5 illustrates a generic node of a communication system according to an embodiment.

FIG. 6 is a flowchart illustrating a process according to an embodiment.

FIG. 7 is a flowchart illustrating a process according to an embodiment.

FIG. 8 illustrates message queues according to an embodiment.

FIG. 9 is a flowchart illustrating a process according to an embodiment.

FIG. 10 is a flowchart illustrating a process according to an embodiment.

FIG. 11 is a flowchart illustrating a process according to an embodiment.

FIG. 12 is a flowchart illustrating a process according to an embodiment.

FIG. 13 is a block diagram of a node according to an embodiment.

### DETAILED DESCRIPTION

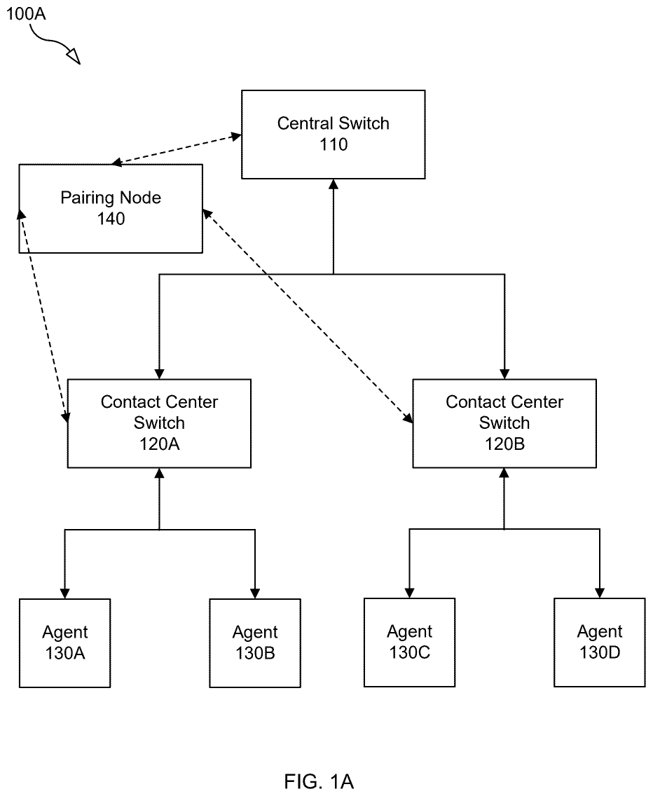

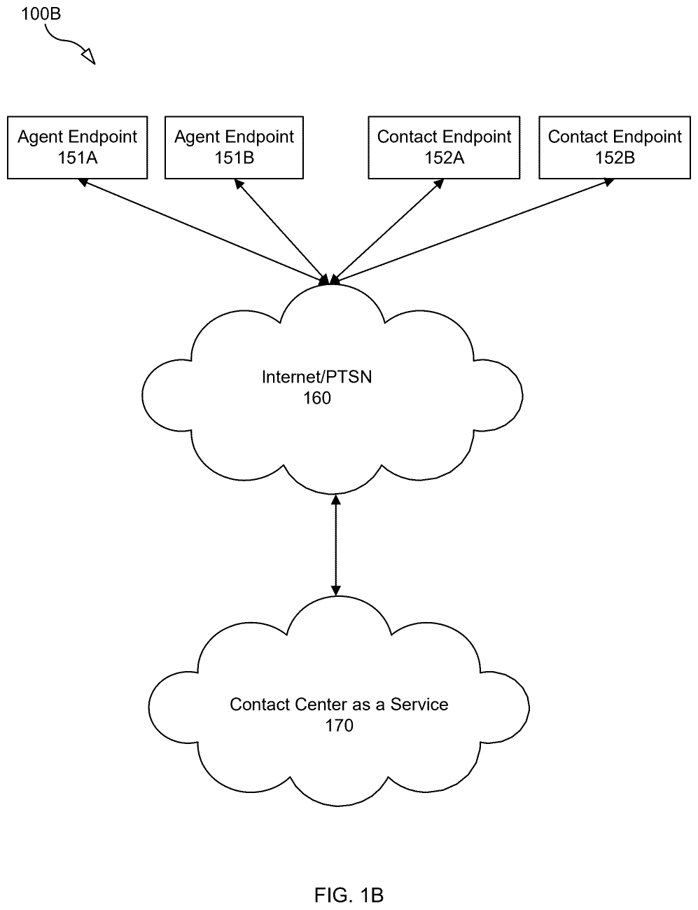

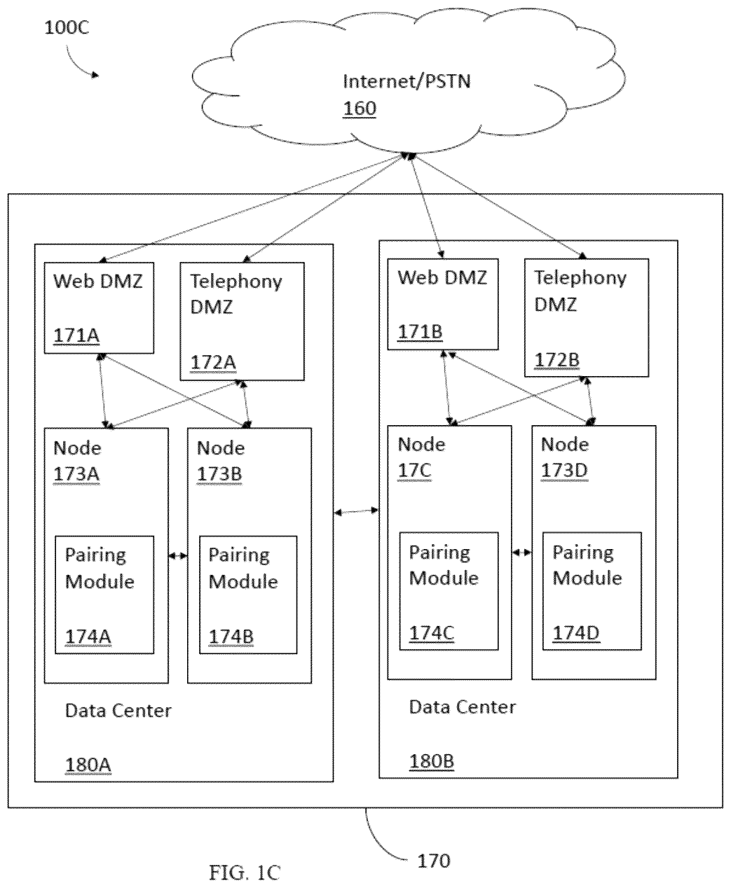

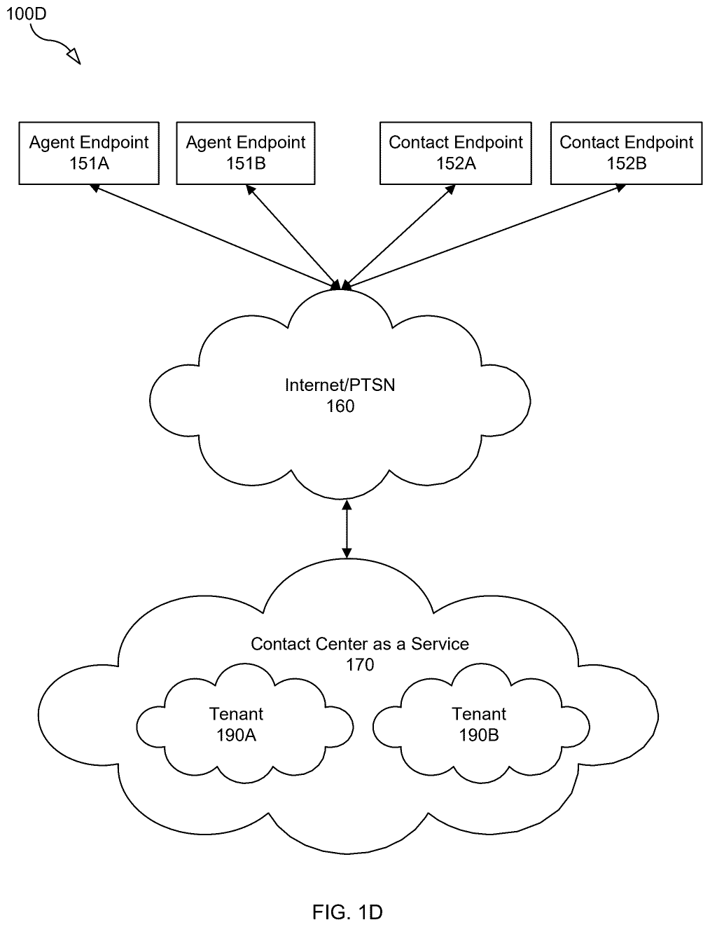

FIG. 1A illustrates an example communication system 100A. In this example, communication system 100A is a contact center system. As shown in FIG. 1A, the communication system 100A may include a central switch 110. The central switch 110 may receive incoming contacts (e.g., callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1A, a pairing node 140 may be communicatively coupled to one or more switches in the switch system of the communication system 100A, such as central switch 110, contact center switch 120A, or contact center switch 120B. In some embodiments, switches of the communication system 100A may be communicatively coupled to multiple pairing nodes. In some embodiments, pairing node 140 may be embedded within a component of a contact center system (e.g., embedded in or otherwise integrated with a switch). The pairing node 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing nodes. In some embodiments, one or more pairing nodes may be components of pairing node 140 or one or more switches such as central switch 110 or contact center switches 120A and 120B. In some embodiments, a pairing node may determine which pairing node may handle pairing for a particular contact. For example, the pairing node may alternate between enabling pairing via a Behavioral Pairing (BP) strategy and enabling pairing with a First-in-First-out (FIFO) strategy. In other embodiments, one pairing node (e.g., the BP pairing node) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone (DMZ) equipment 171A and 171B, respectively, which is configured to receive the agent endpoints 151A, 151B and contact endpoints 152A, 152B, which are communicatively connecting to CCaaS via the Internet. DMZ equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in, First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or 1C) may support multi-tenancy such that multiple contact centers (or contact center operations or businesses) may be operated on a shared environment. That is, multiple tenants, each with their own set of non-overlapping agents, may be handled by the disclosed CCaaS communication systems, where each agent is only interacting with the contacts of a single tenant. CCaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D.

In other embodiments, the system may be configured for a single tenant within a dedicated environment such as a private machine or private virtual machine. In other embodiments, the system may be configured for multiple tenants on the premises of a business process outsourcer (BPO) or other service provider.

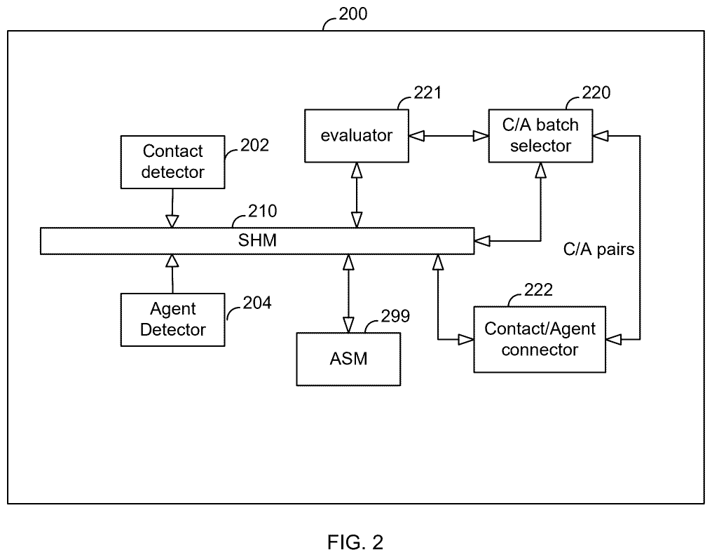

FIG. 2 illustrates an example pairing node 200 according to one embodiment (that is, for example, pairing node 140 of FIG. 1A, or nodes 173A, 173B, 173C, 173D of FIG. 1B may be implemented using pairing node 200). In the embodiment shown, pairing node 200 includes physical memory 210 (e.g., random access memory RAM) such as dynamic RAM (DRAM) or static RAM (SRAM)) for storing contact center information that identifies: (i) a set of contact identifiers (IDs) associated with contacts available for pairing (i.e., contacts waiting to be connected to an agent) and (ii) a set of agent IDs associated with agents of the contact center system. In some embodiments, the contact center information includes: i) for each contact ID, metadata for the contact associated with the contact ID (this metadata may include contact SI indicating whether the contact is available (i.e., waiting to be paired), a score assigned to the contact and/or information about the contact) and ii) for each agent ID, metadata for the agent associated with the agent ID. This metadata for an agent includes agent SI for the agent indicating, for example, whether or not the agent is available for pairing. In one embodiment, the agent SI for an agent comprises a state object that comprises a current state indicator (CSI) indicating a current state of the agent and a pending state indicator (PSI) indicating the agent's pending state. The agent SI for the agent (e.g., state object) may also include a load indicator (LI) indicating the agents load (e.g., indicating has multiple interactions). In one embodiment, the LI is a binary indicator (e.g., the LI can either be 0 indicating that the agent has at most one interaction or the LI can be 1 indicating that the agent has two or more interactions. In other embodiments, the LI may be a continuous value, where a value of the LI is based on a number of interactions that the agent is handling. In still other embodiments, the LI may be a discrete value, such as a determination of how much load the agent is handling on a scale of 0-9. For example, the discrete value may be pre-determined such that each number on the scale corresponds to a predetermined number of interactions; alternatively, the discrete value may be dynamic based on a state of the contact center system and how many interactions are handled by other agents. The metadata for an agent may also include a score assigned to the agent, attributes of the agent, historical contact-agent interaction data, agent percentiles, etc.

Pairing node 200 also includes several modules (software and/or hardware components) (e.g., microservices) including a contact detector 202 and an agent detector 204. Contact detector 202 is operable to detect an available contact (e.g., contact detector 202 may be in communication with a switch that signals contact detector 202 whenever a new contact calls the contact center) and, in immediate response to detecting the available contact, store in memory 210 at least a contact ID associated with the detected contact (the metadata described above may also be stored in association with the contact ID). Similarly, agent detector 204 is operable to detect when an agent becomes available, or experiences another state change event, and, in immediate response to detecting the agent becoming available or other state change event, store in memory 210 at least an agent identifier uniquely associated with the detected agent (metadata pertaining to the identified agent may also be stored in association with the agent ID). In this way, as soon as a contact/agent becomes available, memory 210 will be updated to include the corresponding contact/agent identifier and SI indicating that the contact/agent is available. Hence, at any given point in time, memory 210 will contain a set of zero or more contact identifiers where each is associated with a different contact at the contact center system, and a set of zero or more agent identifiers corresponding to agents of the contact center system.

Pairing node 200 further includes other modules (e.g., microservices) including: (i) a contact/agent (C/A) batch selector 220 that functions to identify (e.g., based on the SI) sets of available contacts and agents for pairing, and provide state updates (i.e., modify the SI) for contacts and agents once the contacts and agents are selected for pairing and (ii) a C/A pairing evaluator 221 that functions to evaluate information associated with available contacts and information associated with available agents in order to propose contact-agent pairings. As shown in FIG. 2, C/A batch selector 220 is in communication with memory 210, and, thereby, can read from memory 210 the contact center information stored therein (including, e.g., a set of contact IDs where each contact ID identifies an available contact and a set of agent IDs where each agent ID identifies an available agent). In one embodiment, C/A batch selector 220 is configured to occasionally (e.g., periodically) read memory 210 to obtain a list of available contacts and available agents based on a state associated with the agents and contacts contained in the memory 210. Further, the C/A batch selector 220 is in contact with a C/A pairing evaluator 221, and, after obtaining a list of available contacts and available agents, the C/A batch selector 220 may send the list to the C/A pairing evaluator 221 (e.g., sending contact IDs and agent IDs to the C/A pairing evaluator 221).

After the C/A pairing evaluator 221 receives a set of contact IDs and agent IDs from the C/A batch selector 220, the C/A pairing evaluator 221 may read from memory 210 further information about the received contact IDs and agent IDs. The C/A pairing evaluator 221 uses the read information in order to identify and propose agent-contact pairings for the received contact IDs and agent IDs based on a pairing strategy, which, depending on the pairing strategy used and the available contacts and agents, may result in no contact/agent pairings, a single contact/agent pairing, or a plurality of contact agent pairings.

Upon identifying contact/agent pairing(s), the C/A pairing evaluator 221 sends the set of contact/agent pairing(s) to the batch selector 220. The C/A batch selector 220 provides the set of contact/agent pairing(s) to a contact/agent connector 222 (e.g., if the contact associated with contact ID C12 is paired with the agent associated with the agent ID A7, then C/A batch selector 220 provides these contact/agent IDs to contact/agent connector 222). Contact/agent connector 222 functions to connect the identified agent with the paired identified contact. For each contact/agent connection, C/A batch selector 220 (or C/A connector 222) stores in memory 210 (e.g., in a message queue in memory 210) a message comprising an event indicator (e.g., “connected), the agent ID, and the contact ID. An agent state manager (ASM) 299 reads the message and, based on the event indicator and a current state object for the identified agent, updates the state object for the identified agent.

Therefore, in one embodiment, pairing node 200 provides an asynchronous polling process where memory 210 provides a central repository that is read and updated by the contact detector 202, agent detector 204, C/A batch selector 220, C/A pairing evaluator 221, and C/A connector 222. Accordingly, the objects of each agent and contact do not need to be moved or copied among the microservices of pairing node 200; instead, identifiers associated with the objects are transmitted or shared among the contact detector 202, agent detector 204, memory 210, C/A batch selector 220, C/A pairing evaluator 221, and C/A connector 222, and the objects stay in place within memory 210, which is shared and accessible to each microservice without the need to rely on an operating system kernel to facilitate data copying among the microservices. This process conserves bandwidth, processing power, memory associated with each microservice, and is more expedient than conventional event-based pairing nodes.

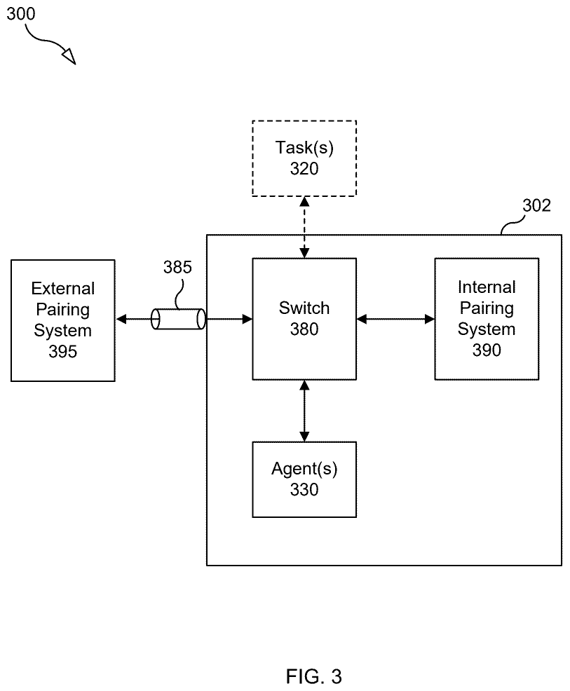

FIG. 3 illustrates another example contact-agent pairing system 300 that includes a task assignment system 302 and an external pairing system 395. In the task assignment system 302, a switch 380 may route a plurality of tasks 320 to a plurality of agents 330. The switch 380 may include routing hardware and software, or one or more PBX or ACD routing components or other queuing or switching components for helping to route the plurality of tasks 320 among the plurality of agents 330.

In the task assignment system 302, an internal pairing system 390 may be communicatively coupled to the switch 380. The internal pairing system 390 may be native to (or built in) the task assignment system 302 (i.e., “first-party”) or may be provided by a third-party vendor. Typically, the internal pairing system 390 may implement traditional pairing strategies (e.g., first-in-first-out (FIFO) or performance based routing (PBR)) or some other pairing strategy that may be proprietary to the task assignment system 302. The internal pairing system 390 may receive or otherwise retrieve information from the switch 380 about the agents 330 logged into the switch 380 and about the incoming tasks 320.

In the contact-agent pairing system 300, the external pairing system 395 may be communicatively coupled to the switch 380 via an interface 385. The interface 385 may isolate the task assignment system 302 from the external pairing system 395 (e.g., for security purposes), and control information exchanged between the two systems. An example of the interface 385 may be a public or a private proprietary application programming interface (API) provided over a network (e.g., the Internet or a telecommunications network) (not shown).

The external pairing system 395 may be provided by a third-party vendor and the external pairing system 395 may provide a pairing strategy (e.g., behavioral pairing (BP)) that improves the performance of the task assignment system 302 when compared to the pairing strategy (or strategies) of the internal pairing system 390. The external pairing system 395 may also provide the same or a similar pairing strategy as that of the internal pairing system 390.

Relative to the internal pairing system 390, the external pairing system 395 may have access to less information associated with switch 380, e.g., a limited subset of information that is selected and shared by the switch 380. Similarly, relative to the internal pairing system 390, the external pairing system 395 may have less control over the operation of switch 380. Such information and/or control is generally sufficient for the external pairing system 395 to determine the task-agent pairing and convey the determined task-agent pairing to switch 380; however, such limited control negatively impacts the performance of the external pairing system 395.

The task assignment system 302 may operate under a shared control, in which the switch 380 may send route requests to either or both of the internal pairing system 390 and the external pairing system 395 to determine which task is to be routed to which agent. The shared control may be desirable, for example, when the internal pairing system 390 employs a traditional or proprietary pairing strategy (e.g., FIFO or PBR) that may not be provided by the external pairing system 395, while the external pairing system 395 is used to provide a higher-performing pairing strategy (e.g., BP).

When the external pairing system (EPS) 395 includes the same or a similar pairing strategy as that of the internal pairing system 390, the task assignment system 302 may operate under full control such that the switch 380 sends all route requests to the external pairing system 395. In other words, the EPS 395 has full control on determining every task-agent pairing. Under the full control, at times, the EPS 395 may simulate/mimic the pairing strategy of the internal pairing system (IPS) 390 (e.g., FIFO or PBR) and, at other times, employ a different pairing strategy (e.g., BP), and send its pairing recommendation to the switch 380 over the interface 385. The switch 380 may then assign the tasks 320 to agents 330 based on the pairing recommendation.

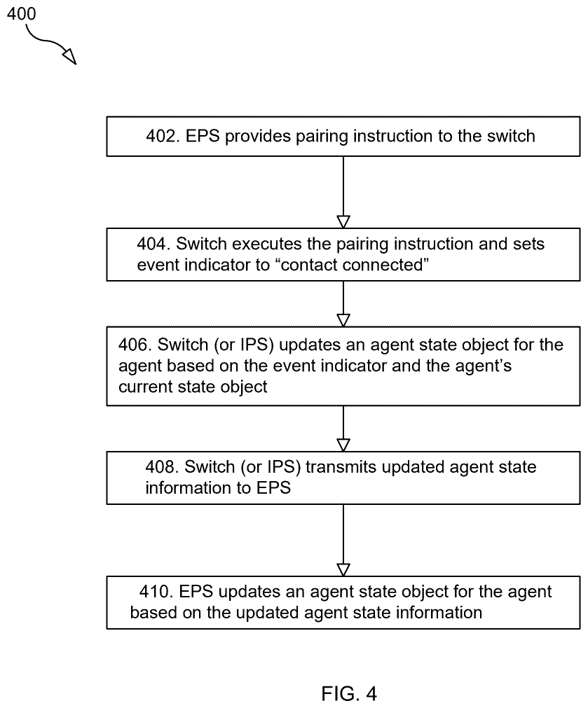

FIG. 4 is a flowchart illustrating a process 400 performed by system 300. In one embodiment, process 400 begins in step 402. Step 402 comprises EPS 395 providing to switch 380 a pairing instruction that includes an agent identifier (ID) identifying an agent and a contact ID identifying the contact with which the agent is to be paired. Step 404 comprises switch 380 executing the pairing instruction (i.e., connecting the agent with a contact). Assuming the switch successfully pairs the agent with the contacts, switch 380 sets an event indicator for the agent to a specific value (e.g., “connected”). Step 406 comprises switch 380 (or IPS 390) updating an agent state object for the agent based on the event indicator and the agent's current state object. Step 408 comprises switch 380 (or IPS 390) transmitting updated agent SI to EPS 395. Step 410 comprises EPS 395 updating its an agent state object for the agent based on the updated agent SI received from system switch 380 (or IPS 390).

Process 400 is inefficient because EPS 395 is reliant on the internal components (e.g., switch 380 and/or IPS 390) maintaining and updating SI for each agent; however, EPS 395 must have accurate SI in order to properly pair agents with contacts, and, accordingly, EPS 395 may experience time delays waiting for switch 380 and/or IPS 390. Such time delays decrease the operating efficiency of EPS 395, as EPS 395 may be required to make multiple pairing decisions per second in a high-throughput contact center environment. Accordingly, systems and methods are needed such that EPS 395 is not reliant on state updates from switch 380 and/or IPS 390.

Further, process 400 is a “stateful” process, requiring sequential processing of pairing instructions and updating SI. If node 200 were used in system 300 according to method 400, various “stateless” features of node 200 would be stalled by process 300. Therefore, there is a need for systems and methods for maintaining agent SI by EPS 395; and, further, there is a need for systems and methods for maintaining agent SI in a stateless and/or lockless manner.

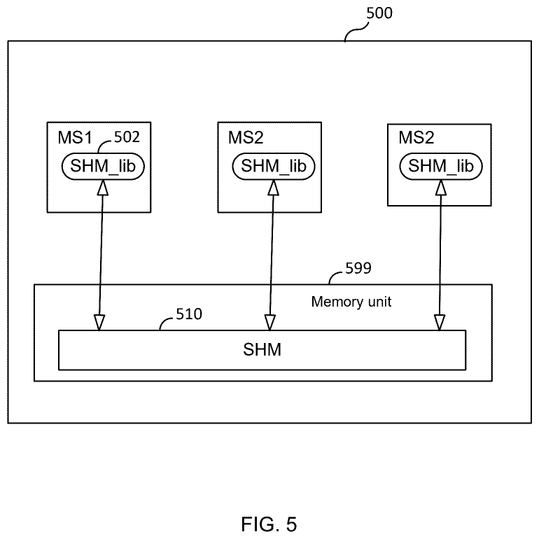

FIG. 5 illustrates a generic node 500 of a communication system according to an embodiment, which may be used to implement pairing node 200. In the embodiment shown, node 500 includes modules (e.g., microservices), such as, for example, the modules described in FIG. 2 (e.g., evaluator 221, batch selector 220, ASM 299 etc.) and a shared memory segment 510 within memory 599. Specifically, in the example shown, node 500 includes three microservices: MS1, MS2, and MS3. Each microservice includes a shared memory submodule 502 (a.k.a., shared memory library (SHM_lib)) that enables the microservice in which it is contained to read from and write to SHM 510. In one embodiment, each microservice is contained within its own container (e.g., a Docker® container). In one embodiment, one or more of the modules of node 200 (e.g., evaluator 221, batch selector 220, etc.) includes an instance of SHM_lib 502. In some embodiments, each microservice is trusted to operate on shared memory segment 510 through functions of SHM_lib 502, eliminating the need for an operating system kernel to manage memory protection among different microservices. Moreover, each microservice may be developed and maintained more efficiently because any complexity of operating on shared memory segment 510 is implemented and managed by the SHM_lib 502 of each microservice.

### Example of State Transitions

When an agent is on a call with contact, the agent's current state may be ‘Connected’. Each agent is always associated with a state object that includes at least i) a current state indicator (CSI) that indicates a current state of the agent, and ii) a pending state indicator (PSI) that indicates a pending state of the agent. The pending state is a state to which the system expects the agent to transition immediately after a resolution of the current state. For example, because an agent should complete ‘After Call Work’ (or ‘ACW’), such as updating notes about a contact's interaction, immediately after a call is terminated, when an agent's current state is ‘Connected’ (i.e., CSI=Connected), the agent typically has a pending state assigned as ACW (i.e., PSI=ACW).

Consider a situation where for a particular agent LI=0, CSI=Connected, PSI=ACW, and the agent tries to go on break by pushing a ‘request break’ button on the agent's interface. In this scenario, the event indicator (EI) would be “on_break.” Based on the LI, CSI, PSI, and EI, ASM 299 would determine for the agent a new PSI (i.e., on_break) and then update the agent's state object so that PSI is changed from ACW to on_break. Note that the CSI remains the same in this scenario.

Consider another situation where for the agent LI=0, CSI-Connected,

PSI=on_break, and the call that the agent is handling terminates naturally. In this scenario, EI=“Call Terminated,” and based on the LI, CSI, PSI, and EI, ASM 299 would determine for the agent a new CSI (i.e., on_break) and then update the agent's state object so that CSI is changed from Connected to on_break. Note that the PSI remains the same in this scenario.

Consider another situation where for the agent LI=0, CSI=on_break, PSI=on_break, and the agent has indicated to the system that the agent is finished with their break. In this scenario, EI=“end_break,” and based on the LI, CSI, PSI, and EI, ASM 299 would determine a new CSI (i.e., idle) and a new PSI (i.e., idle) for the agent and then update the agent's state object so that CSI is changed from on_break to idle and PSI is changed from on_break to Idle.

### Example Events

Table 1 below identifies a set of possible event indicators and corresponding descriptions.

TABLE 1

| Event Indicator (EI) | Description of Event |
|---|---|
| Idle_Request_from_agent | The agent indicates that the agent is available to be paired. For |
| | example, in one embodiment, when a call terminates the agent's |
| | state is transitioned from Connected to ACW, and, to transition |
| | the agent from ACW to idle, the agent must expressly input an |
| | idle request. |
| Idle_Auto | In another embodiment, when a call terminates the agent's state |
| | is transitioned from Connected to ACW and then automatically |
| | transitions from ACW to idle_auto upon the expiration of a set |
| | amount of time. |
| ACW_Request | Agent request to be in ACW state |
| Call_initiated | Agent dialing a number |
| Call_originated | Contact center initiates call between agent and contact. |
| Call_merged | Call transfer or conference scenario |
| Network_Disconnection | Network or TCP connection failure |
| Agent_login | The agent logs in. |
| Agent_logout | The agent logs out. |
| Take_Break | The agent requests to take a break. |
| Call_ringing | Call is ringing. |
| Call_connected | Call is connected. |
| Call_not_connected | Perhaps the call did not connect or is dropped. |
| Call_terminated | Call is terminated. |
| Call_ring_abandoned | Call is abandoned (e.g., while in a ringing state). |
| Forced_Logout | Some contact centers may be configured to have a timer |
| | corresponding to an agent, which expiration of said timer |
| | indicates that the agent should be forced to logout (or have |
| | PSI = logout). |
| HA_Agent_Recovery | In the event of a node failure, or passive node transition to |
| | active node, the agent state may be updated to High Availability |
| | (HA) Agent Recovery, which initiates a recovery process to |
| | check each agent's connection, and then clear and update each |
| | agent's SI. |

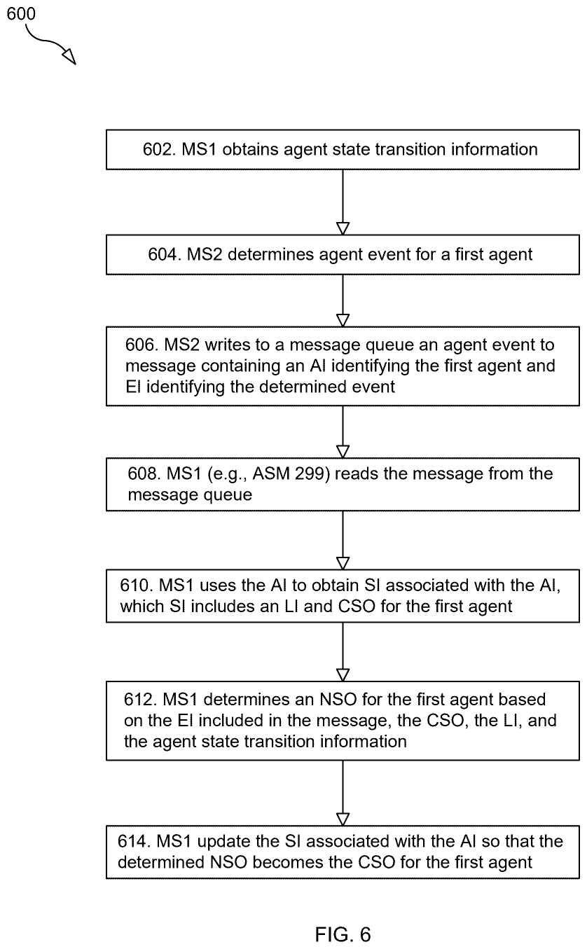

FIG. 6 is a flow chart illustrating a process 600, according to an embodiment, performed by one or more modules of node 200 or 500. Process 600 may begin in step 602.

Step 602 comprises MS1 (e.g. ASM 299) obtaining agent state transition (AST) information. AST information is information that enables MS1 to determine a new state object (NSO) for an agent based on an event indicator (EI), a load indicator (LI) indicating the current load for the agent, and a current state object (CSO) for the agent. Table 2 below illustrates an example of AST information:

TABLE 2

| EI | LI | CSO | NSO |
|---|---|---|---|
| call_terminated | 0 | [CSI = Connected, PSI = ACW] | [CSI = ACW, PSI = idle] |
| call_connected | 0 | [CSI = Idle, PSI = Idle] | [CSI = Connected, PSI = ACW] |
| take_break | 0 | [CSI = Connected, PSI = ACW] | [CSI = Connected, PSI = On Break] |
| . | . | . | . |
| . | . | . | . |
| . | . | . | . |

In the example shown above, a state object is a vector containing two elements: 1) a CSI and 2) a PSI. Because the state vector shown contains two objects, it can also be referred to as a tuple. If the state vector had n elements, then the state vector can be referred to as an “n-tuple.” In some embodiments, the load indicator (LI) is an element of the state object. As an example, given the AST information above in Table 2 and assuming the following for a given agent: EI=call_terminated; LI=0, CSO=[CSI-Connected, PSI=ACW], then the new state object (NSO) for the agent will contain the following information: CSI=ACW, PSI=idle.

Step 604 comprises MS2 determining an agent event for a first agent.

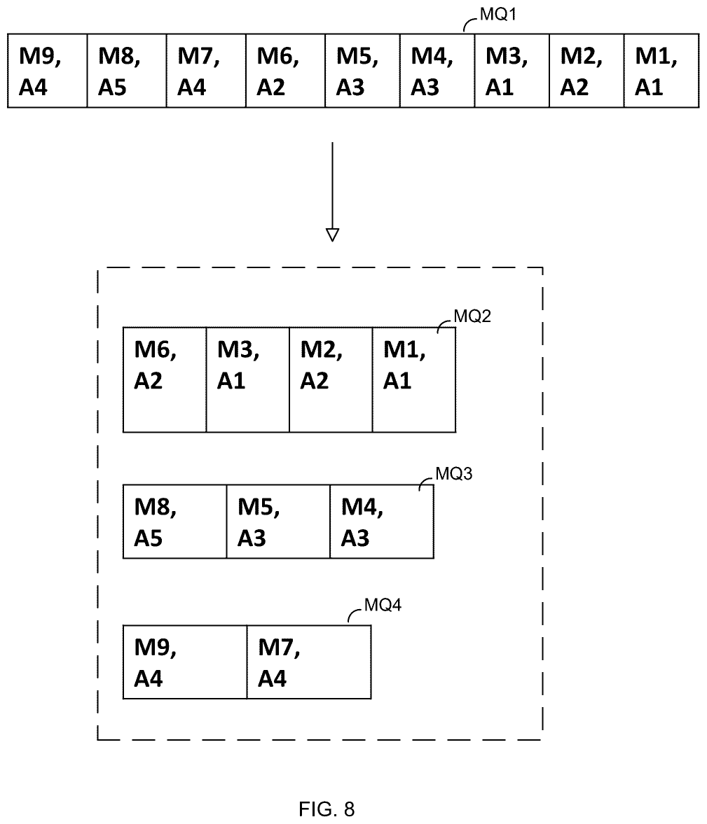

Step 606 comprises MS2 adding a message to a message queue in SHM 510, where the message contains: an agent identifier (AI) that identifies the first agent and an EI that identifies the determined agent event. An example message queue MQ1 is shown in FIG. 8.

Step 608 comprises MS1 (e.g., ASM 299) reading the message from the message queue.

Step 610 comprises MS1 using the AI from the message to obtain SI associated with the AI, which SI includes an LI and CSO for the first agent. In one embodiment, the SI associated with the AI is stored in shared memory segment 510 at a memory location associated with the AI (e.g., the AI may be associated with a memory pointer that points to the memory location).

Step 612 comprises MS1 determining an NSO for the first agent based on the EI included in the message, the CSO, the LI, and the agent state transition information.

Step 614 comprises MS1 updating the stored SI associated with the AI so that the determined NSO becomes the CSO for the first agent (e.g., the CSO in the SI is replaced with the NSO so that the NSO becomes the CSO). The SI associated with the AI may be stored in the shared memory segment 510 at a memory location associated with the AI.

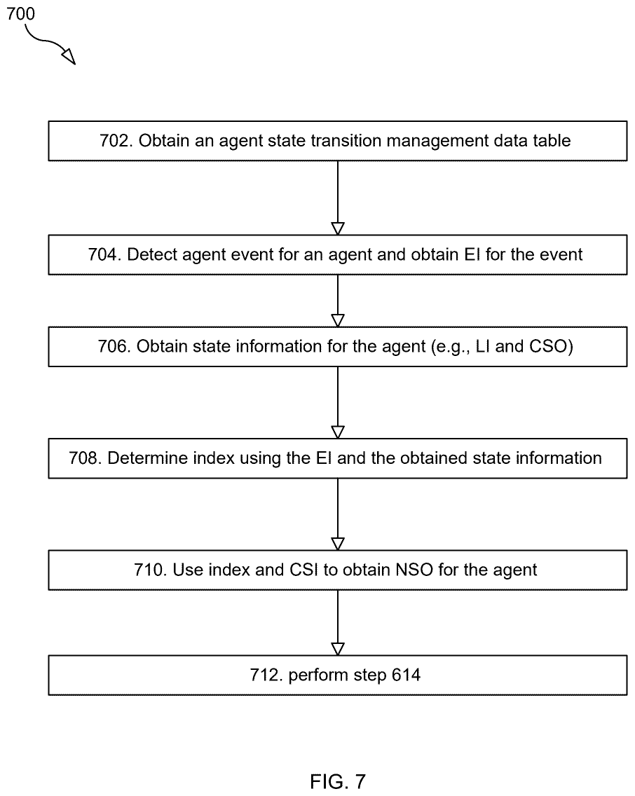

FIG. 7 is a flow chart illustrating a process 700, according to an embodiment, performed by one or more modules of node 200 or 500. Process 700 may begin in step 702.

Step 702 comprises MS1 (e.g. ASM 299) obtaining an agent state transition management data table, an example of which is shown below in Table 3. In the example shown, the table includes M rows where each row is indexed by an index value (e.g., row M is indexed by index value VM); each row includes N new state objects (NSOs); and each field within a row corresponds to a specific state indicator value (e.g., the second field of each row corresponds to the state indicator value of SI_2). Hence, a tuple consisting of an index value and a state indicator value maps to a specific state object. As described below, the agent state transition management data table is another example of AST information (i.e., information that enables MS1 to determine an NSO for an agent based on an EI, a LI, and a CSO for the agent).

TABLE 3

| Index | | | | |
|---|---|---|---|---|
| Value | SI_1 | SI_2 | . . . | SI_N |
| V1 | NSO_1 | NSO_2 | . . . | NSO_N |
| V2 | NSO_N + 1 | NSO_N + 2 | . . . | NSO_N + N |
| V3 | NSO_2N + 1 | NSO_2N + 2 | . . . | NSO_2N + N |
| . | | | | |
| . | | | | |
| . | | | | |
| VM | NSO_(M − 1)N + 1 | NSO_ | . . . | NSO_ |
| | | (M − 1)N + 2 | | (M − 1)N + 1 |

The index value (V) is a value that is a function of: an EI, an LI, and a PSI (i.e., “index value function”). For example, in one embodiment, each value for an EI is associated with a unique numerical value; similarly, each value for a PSI is associated with a unique numerical value. In some examples, the unique numerical values associated with each EI and PSI may be configured such that a function for V results in numerically sequential values for various combinations of EI, LI, and PSI (e.g., V=a row number). In order to achieve such numerically sequential output, the numerical values associated with each EI and PSI may be spaced by an interval of 5, 10, 15, 20, etc. between adjacent EIs/PSIs (i.e., “Interval”). Similarly, a numerically first EI (i.e., “Event Starting Value”) or PSI in a set of numerically-ordered EIs or PSIs may have a starting value which is offset from zero, which starting value may be input into the index value function.

Therefore, for example: V=(((EI−ESV)/Interval)+(PSI×(TE×2)+LI)), where TE is the total number of possible events (e.g., 16) and ESV is the event starting value (e.g., 20). Accordingly, in this embodiment, each EI is a unique integer rather than a unique string of characters and each PSI is a unique integer rather than a unique string of characters. Any other index value function may be used which outputs an appropriate row number for various combinations of EI, PSI, and LI (e.g., V=EI+PSI−LI, V=EI*PSI/Interval+LI, V=LI*Interval+PSI*TE−EI, and/or any other index value formula as may be configured based on EI, PSI, LI, and other variables as contemplated herein). In some examples, the numerical values associated with each EI and PSI may be configured such that multiple combinations of EI, PSI, and LI result in the same index value. Such configurations may increase computational efficiency and speediness of determining a new state object.

The index value function provides a computationally-resource efficient solution and is a method that can be solved quickly (e.g., on the order of milliseconds) in order to determine the correct new state object for a set of inputs. These efficiencies are especially beneficial when the system comprises a large number of possible states and transitions, all of which need to be tracked accurately and quickly for a large number of agents. In some embodiments, the more common new state objects may be sequenced earlier in the table for even greater computational resource and time efficiencies.

Table 4 below shows an example mapping of EIs in character string form to EIs in integer form, and Table 5 below shows an example mapping of PSIs in character string form to PSIs in integer form.

TABLE 4

| EI string form | EI Integer form |
|---|---|
| Idle_Request_from_agent | 20 |
| ACW_Request | 40 |
| Call_initiated | 60 |
| Call_originated | 80 |
| Call_merged | 100 |
| Network_Disconnection | 120 |
| Agent_login | 140 |
| Agent_logout | 160 |
| Take_Break | 180 |
| Call_ringing | 200 |
| Call_connected | 220 |
| Call_not_connected | 240 |
| Call_terminated | 260 |
| Call_ring_abandoned | 280 |
| Forced_Logout | 300 |
| HA_Agent_Recovery | 320 |

TABLE 5

| PSI String form | PSI Integer form |
|---|---|
| Logged_Out | 1 |
| Idle | 2 |
| Connected | 3 |
| ACW | 4 |
| On_Break | 5 |

Step 704 comprises MS1 detecting an agent event, and obtaining EI for the event and an AI identifying the agent to which the agent event applies. For example, in one embodiment, detecting an agent event comprises detecting that an event message has been added to a message queue (e.g., queue MQ1, queue MQ2, queue MQ3, or queue MQ4 shown in FIG. 8) and obtaining the EI and AI comprises reading the EI and AI from the event message.

Step 706 comprises MS1 using the obtained AI to obtain SI for the agent, which SI comprises an LI, CSI, and PSI for the agent.

Step 708 comprises MS1 obtaining index value using the obtained EI, LI, and PSI. For example, MS1 calculates an index value by using a predetermined formula, which formula is configured to output index values for various combinations of EI, ESV, LI, and PSI (e.g., the index value function as discussed above).

Step 710 comprises MS1 using the index value and the obtained CSI to obtain an NSO for the agent (i.e., the NSO to which the tuple consisting of the index value and the obtained CSI is mapped by the agent state transition management data table). For example, MS1 searches the agent state transition management data table for the NSO corresponding to the index value/CSI pair. Using Table 3 as an example, if the index value is V3 and the CSI value is SI_2, then the NSO corresponding to the tuple [V3,SI_2] is NSO_2N+1. As a more specific example, assume that the value V3 was obtained by inputting into the index value formula: EI=260 (which corresponds to event call_terminated), LI=0, and PSI=4 (which corresponds to ACW) and the value of SI_2 is “Connected” or 3, then NSO_2N+1 would be the following tuple: [CSI=ACW,PSI=Idle], which matches what is shown in the first row of Table 2.

Step 712 comprises MS1 performing step 614.

As noted above, for some embodiments, when an event is detected, an event message is added to message queue MQ1 (see FIG. 8), where the message includes an EI indicating the detected event (the EI may be in character string form or integer form) and an AI identifies the agent to which the event applies. But, in some embodiments, it is advantageous to have multiple additional message queues (see, e.g., message queues MQ2, MQ3, and MQ4) because having multiple additional message queues can facilitate parallel processing of event messages.

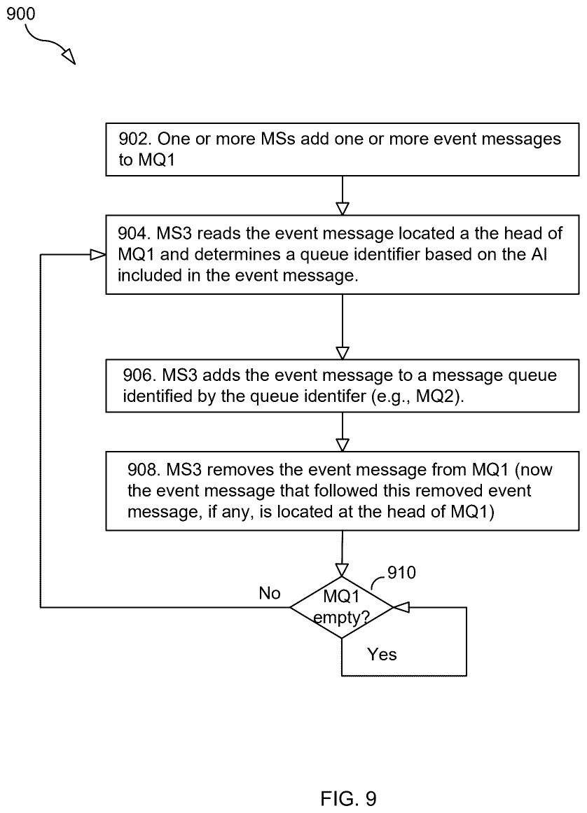

FIG. 9 is a flow chart illustrating a process 900, according to an embodiment, performed by one or more modules of node 200 or 500 for managing event messages. Process 900 may begin in step 902.

Step 902 comprises one or more MSs storing one or more event messages in MQ1. In this embodiment, MQ1 is a FIFO queue (i.e., the message at the head of the queue is the oldest message in the queue, new messages are appended to the tail of the queue).

Step 904 comprises MS3 (or another MS) reading the event message located at the head of MQ1 and determining a queue identifier (QI) based on the AI included in the event message. For example, in one embodiment, determining QI comprises calculating: QI=((AI mod Qn)+2), where Qn is the number of additional message queues (in the example, shown in FIG. 8, Qn=3). In this example, QI will equal 2, 3, or 4. For example, in one embodiment, determining QI comprises determining a hash value based on the AI, and determining the QI based on the hash value. In such a manner, the same AI always returns the same QI.

Step 906 comprises MS3 adding the event message at the head of MQ1 to a message queue associated with the determined QI value (e.g., MQ2, MQ3, or MQ4).

Step 908 comprises MS3 removing the event message from MQ1 (now the event message that followed this removed event message, if any, is located at the head of MQ1).

Step 910 comprises MS3 determining whether MQ1 is now empty. If it is not, process 900 goes back to step 904, otherwise step 910 is repeated.

In the example shown in FIG. 8, QI=2 when AI=A1 or A2; QI=3 when AI=A3 or A5; and QI=4 when AI=A4; and MQ2 is associated with QI=2, MQ3 is associated with QI=3, and MQ4 is associated with QI=4. Hence, messages M1, M2, M3 and M6 are added to MQ2; messages M4, M5, and M8 are added to MQ3; and messages M7 and M9 are added to MQ4. Notably, the messages in secondary queues MQ2, MQ3, and MQ4 are in order per-agent, that is M2, pertaining to A2, is still in front of M6, also pertaining to A2, where M6 was submitted later in time than M2.

In some embodiments, MQ1 is not necessary. In such an embodiment, each module that generates an agent event message associated with an agent determines a QI based on the AI for the agent and then simply adds the event message to the message queue associated with the determined AI. For example, if MS1 generates an event message for the agent associated with agent identifier A4 then MS1 will simply store the event message in MQ3 as there is no need to store the event message in MQ1.

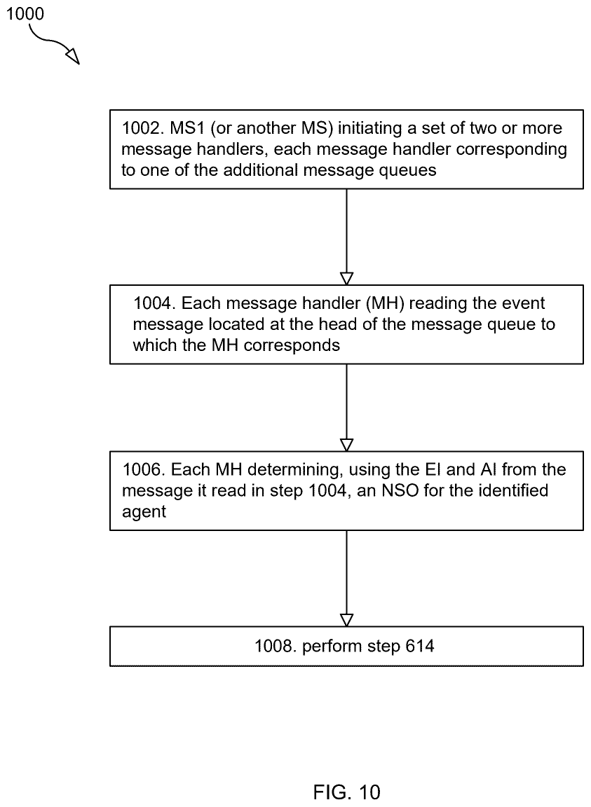

Therefore, the various microservices may submit messages that would update state information for agents in a lockless system, without waiting for the agent state information to be updated beforehand by other microservices. As further described below regarding FIG. 10, the event information for each agent may be processed in order such that the agent state is properly maintained.

FIG. 10 is a flow chart illustrating a process 1000, according to an embodiment, performed by one or more modules of node 200 or 500 for managing event messages. Process 1000 may begin in step 1002.

Step 1002 comprises MS1 (or another MS) initiating a set of two or more message handlers (e.g., a set of threads or a set of processes), each message handler corresponding to one of the additional message queues). Using the message queues of FIG. 8 as an example, MS1 may initiate at least three message handlers, denoted MH2, MH3, and MH4, where MHx corresponds to MQx (i.e., MH2 corresponds to MQ2, MH3 corresponds to MQ3, etc.).

Step 1004 comprises each message handler (MH) reading the event message located at the head of the message queue to which the MH corresponds (i.e., MH2 reads the event message located at the head of MQ2 and MH3 reads the event message located at the head of MQ3). As noted above, each event message contains an EI and AI.

Step 1006 comprises each MH determining, using the EI and AI from the message it read in step 1004, a new state object (NSO) for the identified agent. That is, for example, MH2 determines an NSO using the EI and AI included in the message it read from MQ2. MH2 may implement process 700 to determine the NSO.

Step 1008 comprises each MH performing step 614.

Therefore, process 1000 provides an efficient, multi-threaded process for handling agent state information updates, where updates for different agents may happen simultaneously, instead of each agent update being required to wait in turn for all prior agent events to be handled (e.g., as in process 400).

Altogether, the present disclosure provides systems and methods capable of updating agent state objects for a plurality of agents in a dynamic, high-throughput contact center system. The present disclosure provides systems and methods such that any microservice may cause state updates for any agent. Further, updates to agent information may be ‘resilient’ to impacts from microservices, in that the disclosed agent state information table may function as a finite state machine, permitting certain pathways and excluding other pathways, based on an agent's current state object, event information, and load information.

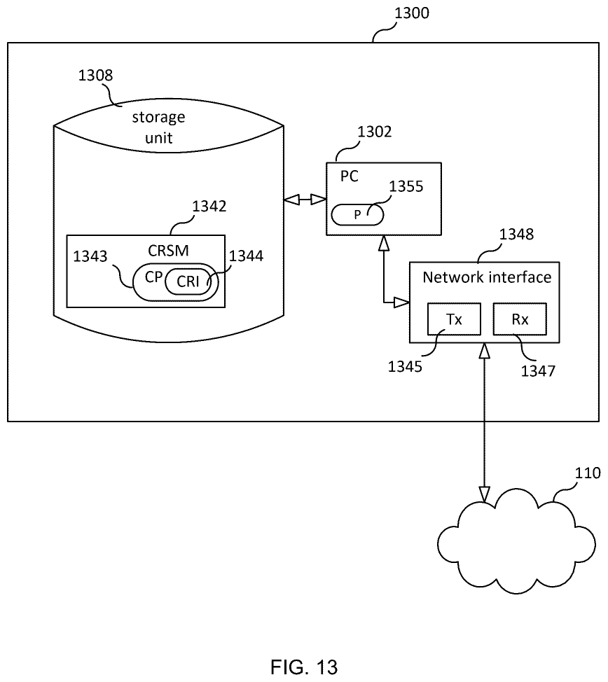

FIG. 13 is a block diagram of a node 1300, according to some embodiments, for performing any of the processes disclosed herein (e.g., node 1300 can function as a pairing node). As shown in FIG. 13, node 1300 may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., node 1300 may be a distributed computing apparatus); at least one network interface 1349 (e.g., a physical interface or air interface) comprising a transmitter (Tx) 1345 and a receiver (Rx) 1347 for enabling node 1300 to transmit data to and receive data from other nodes connected to a network 110 (e.g., an Internet Protocol (IP) network) to which network interface 1349 is connected (physically or wirelessly) (e.g., network interface 1349 may be coupled to an antenna arrangement comprising one or more antennas for enabling node 1300 to wirelessly transmit/receive data); and a storage unit (a.k.a., “data storage system”) 1309, which may include one or more non-volatile storage devices and/or one or more volatile storage devices. In embodiments where PC 1302 includes a programmable processor, a computer readable storage medium (CRSM) 1342 may be provided. CRSM 1342 may store a computer program (CP) 1343 comprising computer readable instructions (CRI) 1344. CRSM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes node 1300 to perform steps described herein (e.g., steps described herein with reference to the flow charts). In other embodiments, node 1300 may be configured to perform steps described herein without the need for code. That is, for example, PC 1302 may consist merely of one or more ASICs. Hence, the features of the embodiments described herein may be implemented in hardware and/or software.

### Summary of Various Embodiments

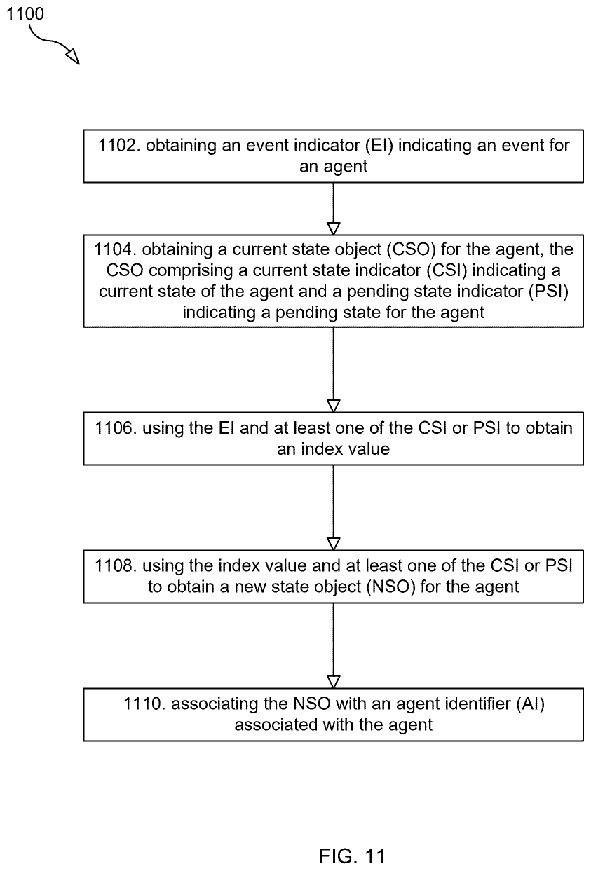

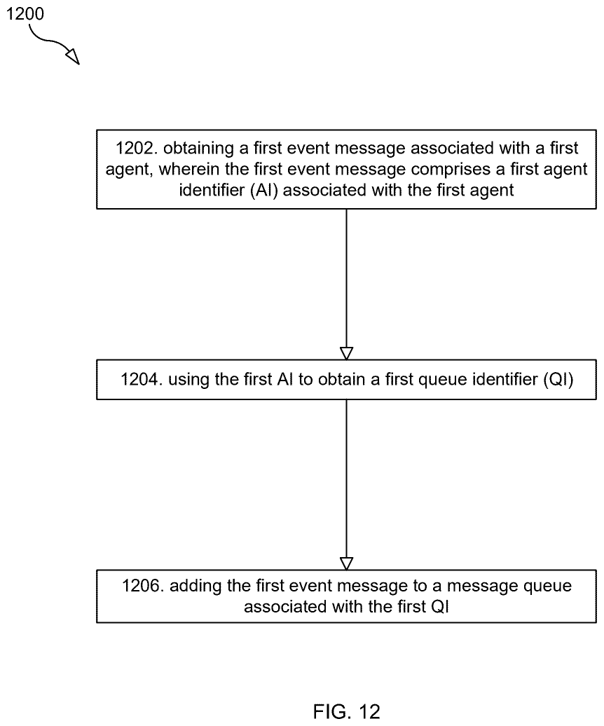

A1. A pairing node comprising: memory; and processing circuitry coupled to the memory, wherein the pairing node is configured to: obtain an event indicator (EI) indicating an event for an agent; obtain a current state object (CSO) for the agent, the CSO comprising a current state indicator (CSI) indicating a current state of the agent and a pending state indicator (PSI) indicating a pending state for the agent; use the EI and at least one of the CSI or PSI to obtain an index value; use the index value and at least one of the CSI or PSI to obtain a new state object (NSO) for the agent; and associate the NSO with an agent identifier (AI) associated with the agent.
A2. The pairing node of embodiment A1, wherein the pairing node is configured to use the index value and at least one of the CSI or PSI to obtain the NSO by performing a process that comprises: using the index value to select a row from an agent state transition management data table; and using the CSI or PSI to select a field from the selected row, wherein the selected field comprises the NSO.
A3. The pairing node of embodiment A1 or A2, wherein the pairing node is configured to use the EI and PSI to obtain the index value by evaluating a function of at least: EI, PSI, and a load indicator (LI).
A4. The pairing node of embodiment A3, wherein evaluating the function comprises calculating one of: EI+PSI−LI, EI×PSI/Interval+LI, (EI−ESV)/Interval+PSI×TE×2+LI, or LI×Interval+PSI×TE−EI, where TE is a total number of possible events, ESV is an event starting value, and Interval is spacing interval.
A5. The pairing node of any one of embodiments A1-A4, wherein the pairing node is configured to obtain the EI by reading from a message queue a message that comprises the EI.
A6. The pairing node of any one of embodiments A1-A5, wherein the pairing node is configured to obtain the CSO for the agent by using the AI to retrieve the CSO from a shared memory.
A7. The pairing node of embodiment A6 when dependent on embodiment A5, wherein the message further comprises the AI, and the pairing node is configured to obtain the AI from the message prior to using the AI to retrieve the CSO.
A8. The pairing node of any one of embodiments A1-A7, wherein the pairing node is configured to associate the NSO with the AI by storing the NSO in a memory location associated with the AI.
B1. A pairing node comprising: memory; and processing circuitry coupled to the memory, wherein the pairing node is configured to: obtain a first event message associated with a first agent, wherein the first event message comprises a first agent identifier (AI) associated with the first agent; use the first AI to obtain a first queue identifier (QI); and add the first event message to a message queue associated with the first QI.
B2. The pairing node of embodiment B1, wherein the pairing node is configured to obtain the first event message by generating the first event message.
B3. The pairing node of embodiment B1 or B2, wherein the pairing node comprises a first message queue (MQ1) for storing the first event message, and the pairing node is configured to obtain the first event message by reading the first event message from MQ1.
B4. The pairing node of embodiment B3, wherein the pairing node is further configured to remove the first event message from MQI after adding the first event message to the message queue associated with the first QI.
B5. The pairing node of any one of embodiments B1-B4, wherein the pairing node is further operable to: obtain a second event message associated with a second agent, wherein the second event message comprises a second AI associated with the second agent; use the second AI to obtain a second QI; and add the second event message to a message queue associated with the second QI.
B6. The pairing node of embodiment B5, wherein the second QI identifies the same message queue as the first QI.
B7. The pairing node of embodiment B5, wherein the second QI identifies a different message queue than the first QI, and the pairing node is further configured to: initiate a first message handler (MH) for processing messages in the message queue associated with the first QI; and initiate a second MH for processing messages in the message queue associated with the second QI.
C1. A method 1100 (see FIG. 11) comprising: obtaining an event indicator (EI) indicating an event for an agent (step 1102); obtaining a current state object (CSO) for the agent, the CSO comprising a current state indicator (CSI) indicating a current state of the agent and a pending state indicator (PSI) indicating a pending state for the agent (step 1104); using the EI and at least one of the CSI or PSI to obtain an index value (step 1106); using the index value and at least one of the CSI or PSI to obtain a new state object (NSO) for the agent (step 1108); and associating the NSO with an agent identifier (AI) associated with the agent (step 1110).
C2. The method of embodiment C1, wherein using the index value and at least one of the CSI or PSI to obtain the NSO comprises: using the index value to select a row from an agent state transition management data table; and using the CSI or PSI to select a field from the selected row, wherein the selected field comprises the NSO.
C3. The method of embodiment C1 or C2, wherein using the EI and PSI to obtain the index value comprises evaluating a function of at least: EI, PSI, and a load indicator (LI).
C4. The method of embodiment C3, wherein evaluating the function comprises calculating one of: EI+PSI−LI, EI×PSI/Interval+LI, (EI−ESV)/Interval+PSI×TE×2+LI, or LI×Interval+PSI×TE−EI, where TE is a total number of possible events, ESV is an event starting value, and Interval is spacing interval.
C5. The method of any one of embodiments C1-C4, wherein obtaining the EI comprises reading from a message queue a message that comprises the EI.
C6. The method of any one of embodiments C1-C5, wherein obtaining the CSO for the agent comprises using the AI to retrieve the CSO from a shared memory.
C7. The method of embodiment C6 when dependent on embodiment C5, wherein the message further comprises the AI, and obtaining the AI from the message prior to using the AI to retrieve the CSO.
C8. The method of any one of embodiments C1-C7, wherein associating the NSO with the AI comprises storing the NSO in a memory location associated with the AI.
D1. A method 1200 (see FIG. 12) comprising: obtaining a first event message associated with a first agent, wherein the first event message comprises a first agent identifier (AI) associated with the first agent (step 1202); using the first AI to obtain a first queue identifier (QI) (step 1204); and adding the first event message to a message queue associated with the first QI (step 1206).
D2. The method of embodiment D1, wherein obtaining the first event message comprises generating the first event message.
D3. The method of embodiment D1 or D2, wherein storing the first event message in a first message queue (MQ1), and obtaining the first event message comprises reading the first event message from MQ1.
D4. The method of embodiment D3, further comprising removing the first event message from MQI after adding the first event message to the message queue associated with the first QI.
D5. The method of any one of embodiments D1-D4, further comprising: obtaining a second event message associated with a second agent, wherein the second event message comprises a second AI associated with the second agent; using the second AI to obtain a second QI; and adding the second event message to a message queue associated with the second QI.
D6. The method of embodiment D5, wherein the second QI identifies the same message queue as the first QI.
D7. The method of embodiment D5, wherein the second QI identifies a different message queue than the first QI, and the method further comprises: initiating a first message handler (MH) for processing messages in the message queue associated with the first QI; and initiating a second MH for processing messages in the message queue associated with the second QI.
E1. A computer program comprising instructions which when executed by processing circuitry of a node causes the node to perform the method of any one of embodiments C1-C8 or D1-D7.
E2. A carrier containing the computer program of embodiment E1, wherein the carrier is one of an electronic signal, an optical signal, a radio signal, and a computer readable storage medium (1342).

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A pairing node comprising:
memory; and
processing circuitry coupled to the memory, wherein the pairing node is configured to:
obtain an event indicator (EI) indicating an event for an agent;
obtain a current state object (CSO) for the agent, the CSO comprising a current state indicator (CSI) indicating a current state of the agent and a pending state indicator (PSI) indicating a pending state for the agent;
use the EI and at least one of the CSI or PSI to obtain an index value;
use the index value and at least one of the CSI or PSI to obtain a new state object (NSO) for the agent; and
associate the NSO with an agent identifier (AI) associated with the agent.

2. The pairing node of claim 1, wherein the pairing node is configured to use the index value and at least one of the CSI or PSI to obtain the NSO by performing a process that comprises:
using the index value to select a row from an agent state transition management data table; and
using the CSI or PSI to select a field from the selected row, wherein the selected field comprises the NSO.

3. The pairing node of claim 1, wherein the pairing node is configured to use the EI and PSI to obtain the index value by evaluating a function of at least: EI, PSI, and a load indicator (LI).

4. The pairing node of claim 3, wherein evaluating the function comprises calculating one of:
$$EI + PSI - LI ,$$
$$EI \times PSI / Interval + LI ,$$
$$( EI - ESV ) / Interval + PSI \times TE \times 2 + LI , or$$
$$LI \times Interval + PSI \times TE - EI ,$$
where
TE is a total number of possible events,
ESV is an event starting value, and
Interval is spacing interval.

5. The pairing node of claim 1, wherein
the pairing node is configured to obtain the EI by reading from a message queue a message that comprises the EI, and/or
the pairing node is configured to obtain the CSO for the agent by using the AI to retrieve the CSO from a shared memory.

6. The pairing node of claim 5, wherein
the message further comprises the AI, and
the pairing node is configured to obtain the AI from the message prior to using the AI to retrieve the CSO.

7. The pairing node of claim 1, wherein the pairing node is configured to associate the NSO with the AI by storing the NSO in a memory location associated with the AI.

8. A pairing node comprising:
memory; and
processing circuitry coupled to the memory, wherein the pairing node is configured to:
obtain a first event message associated with a first agent, wherein the first event message comprises a first agent identifier (AI) associated with the first agent;
use the first AI to obtain a first queue identifier (QI); and
add the first event message to a message queue associated with the first QI.

9. The pairing node of claim 8, wherein the pairing node is configured to obtain the first event message by generating the first event message.

10. The pairing node of claim 8, wherein
the pairing node comprises a first message queue (MQ1) for storing the first event message, and
the pairing node is configured to obtain the first event message by reading the first event message from MQ1.

11. The pairing node of claim 10, wherein the pairing node is further configured to remove the first event message from MQI after adding the first event message to the message queue associated with the first QI.

12. The pairing node of claim 8, wherein the pairing node is further operable to:
obtain a second event message associated with a second agent, wherein the second event message comprises a second AI associated with the second agent;
use the second AI to obtain a second QI; and
add the second event message to a message queue associated with the second QI.

13. The pairing node of claim 12, wherein the second QI identifies the same message queue as the first QI.

14. The pairing node of claim 12, wherein
the second QI identifies a different message queue than the first QI, and
the pairing node is further configured to:
initiate a first message handler (MH) for processing messages in the message queue associated with the first QI; and
initiate a second MH for processing messages in the message queue associated with the second QI.

15. A method comprising:
obtaining an event indicator (EI) indicating an event for an agent;
obtaining a current state object (CSO) for the agent, the CSO comprising a current state indicator (CSI) indicating a current state of the agent and a pending state indicator (PSI) indicating a pending state for the agent;
using the EI and at least one of the CSI or PSI to obtain an index value;
using the index value and at least one of the CSI or PSI to obtain a new state object (NSO) for the agent; and
associating the NSO with an agent identifier (AI) associated with the agent.

16. The method of claim 15, wherein using the index value and at least one of the CSI or PSI to obtain the NSO comprises:
using the index value to select a row from an agent state transition management data table; and
using the CSI or PSI to select a field from the selected row, wherein the selected field comprises the NSO.

17. The method of claim 15, wherein using the EI and PSI to obtain the index value comprises evaluating a function of at least: EI, PSI, and a load indicator (LI).

18. The method of claim 17, wherein evaluating the function comprises calculating one of:
$$EI + PSI - LI ,$$
$$EI \times PSI / Interval + LI ,$$
$$( EI - ESV ) / Interval + PSI \times TE \times 2 + LI , or$$
$$LI \times Interval + PSI \times TE - EI ,$$
where
TE is a total number of possible events,
ESV is an event starting value, and
Interval is spacing interval.

19. The method of claim 16, wherein obtaining the EI comprises reading from a message queue a message that comprises the EI.

20. A method comprising:
obtaining a first event message associated with a first agent, wherein the first event message comprises a first agent identifier (AI) associated with the first agent;
using the first AI to obtain a first queue identifier (QI); and
adding the first event message to a message queue associated with the first QI.
